(19) United States
(12) Patent Application Publication
(10) Pub. No.: US 2025/0373349 A1
(43) Pub. Date: Dec. 4, 2025

(54) System and Method for Determining Energy-Savings States of Cells in Event Zones Using Trained Machine Learning Model

(71) Applicant: P. I. Works U.S., Inc., Reston, VA (US)

(72) Inventors: Yakup Tarik Kranda, Reston, VA (US); Ubeyde Mavus, Kartal (TR); Sina Alp, Maltepe (TR); Ahmet Serkan Sofuoglu, San Ramon, CA (US)

(21) Appl. No.: 18/676,819

(22) Filed: May 29, 2024

(51) Int. Cl. H04B 17/391; H04W 24/02; H04W 52/02

(52) U.S. Cl. CPC H04B 17/3913; H04W 24/02; H04W 52/0203

(57) ABSTRACT

A method for determining energy-savings states of cellular network components comprises retrieving run-time performance metric data for cells in a predetermined area corresponding to an event location; feeding the run-time performance metric data to a trained machine-learning (ML) model; determining, using the trained ML model and the run-time performance metric data, predicted cell utilization levels over a predicted time period; comparing one or more predicted cell utilization levels for each cell to a respective threshold; and building an inclusion list that identifies each cell for which at least one of the respective predicted cell utilization level(s) is/are lower than or equal to the respective threshold(s) and a respective one or more predicted time increments in which the at least one of the respective predicted cell utilization level(s) of a respective cell is/are lower than or equal to the respective threshold(s).

### TECHNICAL FIELD

This application relates generally to cellular wireless networks.

### BACKGROUND

Exponentially increasing cost due to energy consumption in parallel to continuously rising demand for mobile data, and the global awareness for threatening climate change cause heavy pressure on Mobile Network Operators (MNOs) to minimize energy consumption within their networks. Given that quite a notable portion of energy costs depends on the Radio Access Networks (RANS), many MNOs have implemented various automated energy saving solutions by taking some automated actions such as smooth deactivation of Radio Network Elements (RNEs) during idle periods of the day, dynamic optimization of advanced 5G sleep modes, energy efficient management of massive MIMO (Multiple Input Multiple Output) antennas.

MNOs rely on their reputation to attract and retain customers and a failure to provide reliable and high-quality service could damage their reputation. Additionally, there are regulations specific to each country aimed at ensuring the provision of dependable MNO services. These regulations are in place to maintain public accessibility and awareness of coverage and capacity requirements. Overall, these regulations mean mobile network operators could be held liable if they fail to comply with the regulation requirements. Considering all these business and regulatory requirements, MNOs tend to prioritize minimizing risks related to service and capacity availability over pursuing energy-saving opportunities to provide the highest capacity. This is because of concerns about their financial, reputational, and legal implications. Especially in crowded event zones within their radio network areas, the pressure on potential capacity demand surges, so in the most extreme cases, energy efficiency-based optimization efforts are totally abandoned for all RNEs to stay in the safe zone during nearby popular events such as concert venues, sport events, inter-city transportation paths, and designated meeting points.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a method for determining energy-savings states of cellular network components in an event zone, comprising retrieving, with a decision module, run-time performance metric data for cells in a predetermined area of a cellular wireless network corresponding to an event location, the run-time performance metric data representing a predetermined time period before a start time of an event; feeding the run-time performance metric data to a trained machine-learning (ML) model in the decision module, the trained ML model having been trained with first historical performance metric data representing no events at the event location and second historical performance metric data representing events at the event location; determining, using the trained ML model and the run-time performance metric data, predicted cell utilization levels for the cells over a predicted time period, the predicted time period subdivided into a plurality of predicted time increments; comparing, with the decision module, one or more respective predicted cell utilization levels for each cell to one or more respective thresholds; and building, with the decision module, an inclusion list that includes an identity of each cell for which at least one of the one or more respective predicted cell utilization levels is/are lower than or equal to the one or more respective thresholds, the inclusion list further including a respective one or more predicted time increments in which the at least one of the one or more respective predicted cell utilization levels of a respective cell is/are lower than or equal to the one or more respective thresholds.

In one or more embodiments, the method further comprises sending the inclusion list from the decision module to a Radio Access Network Energy Saving (RAN ES) Module, the RAN ES Module configured to cause each cell identified in the inclusion list to transition from an operational state to an energy-savings state during the respective one or more time periods.

In one or more embodiments, the one or more respective predicted cell utilization levels comprises a respective downlink physical resource block utilization, an uplink physical resource block utilization. In one or more embodiments, the one or more respective predicted cell utilization levels comprises respective connected enhanced radio resource control user numbers. In one or more embodiments, the one or more respective predicted cell utilization levels comprises a respective downlink physical resource block utilization, a respective uplink physical resource block utilization, and respective connected enhanced radio resource control user numbers.

In one or more embodiments, the respective one or more predicted time increments is/are one or more predicted first time increments, and the method further comprises building an exclusion list that includes the identity of each cell having the at least one of the one or more respective predicted cell utilization levels that is/are higher than the one or more respective thresholds, the exclusion list further including a respective one or more second predicted time increments in which the at least one of the one or more respective predicted cell utilization levels of a respective cell is/are higher than at least one of the one or more respective thresholds. In one or more embodiments, the method further comprises sending the exclusion list from the decision module to a Radio Access Network Energy Saving (RAN ES) Module, the RAN ES Module configured to cause each cell identified in the exclusion list to be excluded from entering into an energy-savings state during the respective one or more second predicted time increments.

In one or more embodiments, the trained ML model comprises a trained graph neural network (GNN). In one or more embodiments, the first historical performance metric data, the second historical performance metric, and the run-time performance metric data are represented as a plurality of graph networks. In one or more embodiments, each graph network includes a plurality of nodes and one or more edges, each node representing the respective cell and each edge has a respective weight corresponding to an average number of handover activities between a respective pair of cells. In one or more embodiments, the average number of handover activities includes an average number of handover attempts between the respective pair of cells and/or an average number of handover completions between the respective pair of cells. In one or more embodiments, each node has one or more respective node features including a total uplink and/or a total downlink data traffic volume, a downlink physical resource block utilization, an uplink physical resource block utilization, connected enhanced radio resource control user numbers, and/or the average number of handover activities.

Another aspect of the invention is directed to a computer comprising a processor; non-transitory memory operably coupled to the processor, the non-transitory memory storing computer-readable instructions that, when executed by the processor, cause the processor to run a decision module for determining energy-savings states of cellular network components in an event zone, the decision module configured to retrieve run-time performance metric data for cells in a predetermined area of a cellular wireless network corresponding to an event location, the run-time performance metric data representing a predetermined time period before a start time of an event; feed the run-time performance metric data to a trained machine-learning (ML) in the decision module, the trained ML model having been trained with first historical performance metric data representing no events at the event location and second historical performance metric data representing events at the event location; determine, using the trained ML model and the run-time performance metric data, predicted cell utilization levels for the cells over a predicted time period, the predicted time period subdivided into a plurality of predicted time increments; compare one or more respective predicted cell utilization levels for each cell to one or more respective thresholds; and build an inclusion list that includes an identity of each cell for which at least one of the one or more respective predicted cell utilization levels is/are lower than or equal to the one or more respective thresholds, the inclusion list further including a respective one or more predicted time increments in which the at least one of the one or more respective predicted cell utilization levels of a respective cell is/are lower than or equal to the one or more respective thresholds.

In one or more embodiments, the decision module is further configured to send the inclusion list from the decision module to a Radio Access Network Energy Saving (RAN ES) Module, the RAN ES Module configured to cause each cell identified in the inclusion list to transition from an operational state to an energy-savings state during the respective one or more time periods. In one or more embodiments, the trained ML model comprises a trained graph neural network (GNN).

In one or more embodiments, the respective one or more predicted time increments is/are one or more predicted first time increments, and the decision module is further configured to build an exclusion list that includes the identity of each cell having the at least one of the one or more respective predicted cell utilization levels that is/are higher than the one or more respective thresholds, the exclusion list further including a respective one or more second predicted time increments in which the at least one of the one or more respective predicted cell utilization levels of a respective cell is/are higher than at least one of the one or more respective thresholds.

Another aspect of the invention is directed to a method for training a graph neural network (GNN) to predict cell utilization levels for an event zone, comprising collecting first performance metric data for cells in a predetermined area surrounding an event venue at a plurality of first times when no events are occurring at the event venue; collecting second performance metric data for the cells in the predetermined area at a plurality of second times when events are occurring at the event venue; and training the GNN with the first and second performance metric data.

In one or more embodiments, the training includes minimizing an error between true values and predicted values. In one or more embodiments, the method further comprises converting the first performance metric data to a plurality of first graph networks; converting the second performance metric data to a plurality of second graph networks; and training the GNN with the first and second graph networks, wherein each of the first and second graph networks includes a plurality of nodes and one or more edges, each node representing a respective cell and each edge has a respective weight corresponding to an average number of handover activities between a respective pair of cells, the average number of handover activities including an average number of handover attempts between the respective pair of cells and/or an average number of handover completions between the respective pair of cells. In one or more embodiments, each node has one or more respective node features including a total uplink and/or a total downlink data traffic volume, a downlink physical resource block utilization, an uplink physical resource block utilization, connected enhanced radio resource control user numbers, and/or the average number of handover activities.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a block diagram of an area of a cellular wireless network surrounding an event location according to an embodiment.

FIG. 2 is a flow chart of a method for training a graph neural network (GNN) model according to an embodiment.

FIG. 3 shows a simplified model of a GNN according to an embodiment.

FIG. 4 shows a specific implementation of a GNN according to an embodiment.

FIG. 5 shows an example graph network at an example timestep for a cellular wireless network.

FIG. 6 illustrates example training data used to train a GNN.

FIG. 7 is a flow chart of a method for determining energy-savings states of cells in a cellular wireless network in an event zone according to an embodiment.

FIG. 8 illustrates an example of a final prediction layer of a trained GNN.

### DETAILED DESCRIPTION

Predicting the behavior of crowds accurately is essential to ensure optimal network performance, and maintenance of service quality with predictive optimization actions. Once a prediction model is being used to forecast traffic patterns in a city which is trained over historical subscriber patterns, it turns into a more manageable environment for Mobile Network Operators (MNOs) to carry out energy savings around planned special event zones and city transportation hubs. The gathering and examination of past crowd dispersal patterns from event areas to residences, with the intention of training machine learning (ML) models, holds significant value. By predicting capacity demand surges from crowd movements, MNOs can optimize energy savings by selectively halting activities at nearby radio network elements (e.g., cells), departing from traditional approaches that involve stopping all saving activities. Our work provides an automatically generated exclusion list (blacklist) for energy saving activities specific to each radio network element during planned crowded events in nearby locations to event venues.

A radio network capacity demand prediction module is disclosed. This module integrates spatial and temporal network metrics through the utilization of graph neural networks (GNNs). The GNN can be trained specifically for scheduled and repetitive events. This sets it apart from existing city crowd analysis solutions, which typically rely on various data types such as images, videos, satellite information, and/or mobile car traffic sensors.

Additionally, our approach extends beyond conventional approaches by leveraging machine learning models tailored to our specific requirements. These models encompass diverse techniques, such as time series prediction models and various neural network layers. Existing solutions typically address distinct problems, such as transportation vehicle management, energy-grid optimization, or crowd congestion management. Our approach is to predict radio network capacity demand in planned and recurring event zones, offering a novel and specialized solution in this domain. In contrast to conventional prediction models, our approach reduces the probability of inaccurate predictions associated with planned special events. Predictions are generated using a time series of key performance indicators (KPIs) calculated individually for each radio network element (e.g., cell) based on their metrics (e.g., performance counters of radio network equipment).

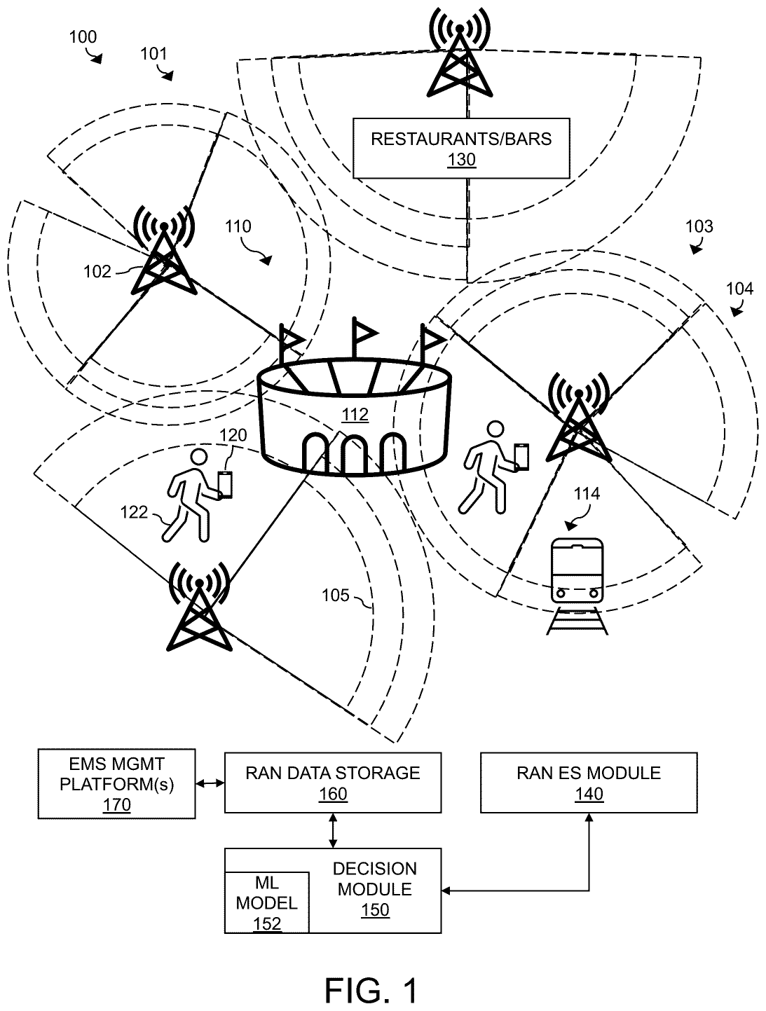

FIG. 1 is a block diagram of an area 100 of a cellular wireless network 101 surrounding an event location 110 according to an embodiment. The cellular wireless network 101 includes a plurality of base stations 102 with each base station 102 having a respective cellular coverage area 103. The cellular coverage area 103 of each base station 102 is divided into a plurality of sectors 104 that represent respective directions of cellular wireless coverage. Each sector 104 includes one or more cells 105. Each cell 105 can have the same direction within a geographic coverage area within a sector 104. Multiple cells 105 can be included in a given sector 104 to increase capacity.

The base stations 102 are in different physical locations so as to have different cellular coverage areas 103 which may at least partially overlap to provide continuity in coverage of the cellular wireless network 101 as user equipment (UE) 120, such as cellular phones (e.g., smartphones), tablets, and/or other cellular devices, are moved by people 122 within the area 100.

The demands on the cellular wireless network 101 in the area 100 are different depending on whether an event occurs at a stadium 112 (or other venue) at the event location. When an event occurs, some people 122 may arrive early and spend time in nearby restaurants and/or bars 130. During the event, and some period of time before the event start time and/or after the event end time, the stadium 112 is typically crowded with people 122. After the event end time, another location, such as a nearby transportation center 114, may be crowded with people 122. When an event does not occur, there are typically much fewer people 122 in the area 100 compared to when an event occurs. The demands on the cellular wireless network 101 generally follows the movement, location, and number of people 122 discussed above.

To conserve energy, a Radio Access Network Energy Saving (RAN ES) Module can place one or more of the cells 105 into an energy-savings state. When a cell 105 is in an energy-savings state, some of the software and hardware components of the base station 102 are powered off to temporarily place the cell 105 out of service. When a cell 105 is not in an energy-savings state (e.g., in an operational state), the software and hardware components for that cell 105 are powered on and the cell 105 is in service. The RAN ES Module 140 is in communication (e.g., electrically and/or wirelessly) with the base stations 102 directly or indirectly (not shown in FIG. 1) for example via Element Management System (EMS) management platform(s) 170 and can send control signals to each base station 102 to set the state (e.g., energy-savings state or operational state) of the cells 105 for each base station 102.

A decision module 150 can determine the state of each cell 105 in the area 100 using a trained ML model 152. The decision module 150 can be implemented in software, for example as a web service on a virtual machine in a Mobile Network Operator data center. The software can be run on a computer or on a server that includes a processor and non-transitory memory operably coupled to the processor. The non-transitory memory stores computer-readable instructions that, when executed by the processor, cause the processor to run the decision module 150.

The trained ML model 152 can predict the demands on each cell 105 using, as an input, performance metric data for the area 100 of the cellular wireless network 101 from a predetermined time period before the start of a scheduled event. The trained ML model 152 can comprise a trained GNN model such as a trained convolutional GNN model, a trained Graph Convolutional Network (GCN), or a trained recurrent GNN (R-GNN). The performance metric data can be provided by Radio Access Network (RAN) data storage 160, which is in communication (e.g., wired and/or wireless communication) with EMS management platform(s) 170 and with the decision module 150. RAN data storage 160 can store certain RAN performance metric data for the cells 105 and performance metrics between neighboring cells 105. These metrics can include collected EMS logs and can be collected by an EMS management platform 170 of an OEM vendor (original equipment manufacturer) (e.g., Ericsson, Huawei, Nokia, Samsung, etc.). RAN data storage 160 also hosts geolocated call trace event details which are extracted by processing detailed messages in call trace logs collected from EMS and enriched with session information in Core Network (CN) (not shown in FIG. 1) which is a switching function/node of cellular wireless network 101 that connects base stations 102. RAN data storage 160 can include mediation software to perform operations such to connect EMS systems, execute necessary commands to export data into specific formats (generally XML, JSON, or CSV), then download those PM and CM reports to local servers and process them (e.g., Extract, Transform and Load (ETL)) and write into that data storage.

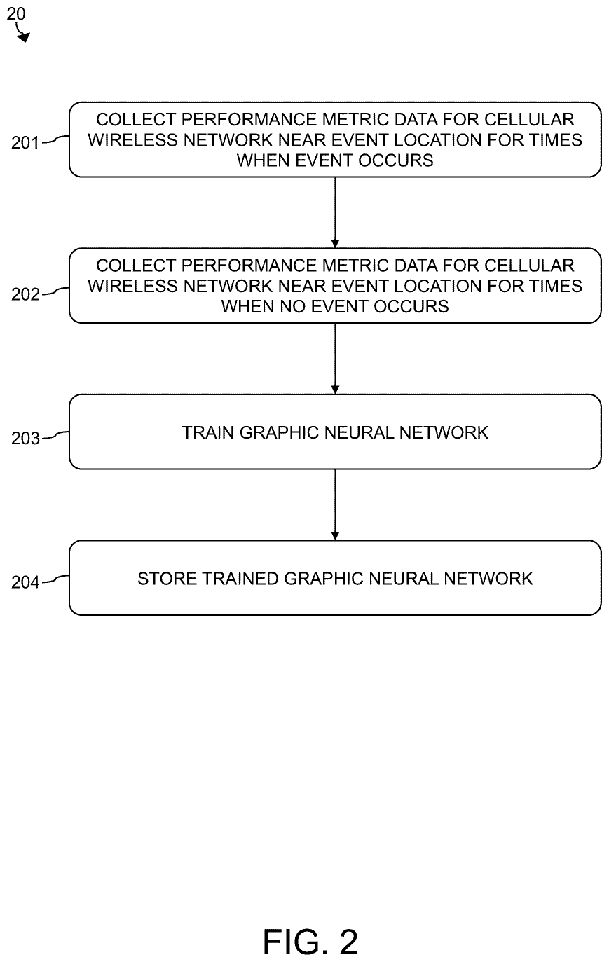

FIG. 2 is a flow chart of a method 20 for training a GNN model, for example to produce the trained ML model 152.

In step 201, performance metric data for each cell 105 in the area 100 are collected for days (or time periods) in which a scheduled event occurred. The performance metric data can be collected by one or more EMS management platforms 170. The EMS management platform(s) 170 can collect performance metric data at regular intervals, such as every 15 minutes. The mediation software running on the RAN data storage 160 can collect and aggregate the performance metric data from the EMS management platform(s) 170, for example by connecting to the Northbound interface of each EMS management platform 170. The performance metric data can include KPIs such as total data traffic volume (e.g., downlink and/or uplink total data traffic volume), downlink physical resource block (PRB) utilization, uplink PRB utilization, connected enhanced RRC radio resource control (eRRC) user numbers (count), and/or the average number of handover activities (e.g., average number of handover completions and/or average number of handover attempts) between cells 105. In some embodiments, the performance metric data can the total data traffic volume (e.g., downlink and/or uplink total data traffic volume), downlink PRB utilization, uplink PRB utilization, connected eRRC user numbers (count), and the average number of handover activities (e.g., average number of handover completions and/or average number of handover attempts) between cells 105.

PRB utilization refers to a ratio of used PRB count to available PRB count (e.g., 50, 75, 100) in a cell where available PRB count is associated with a cell channel bandwidth (BW) (e.g. BW=20 Megahertz corresponds to available PRB=100 in Long Term Evolution (LTE) cellular standard). The performance metric data can also include geolocated call trace logs.

eRRC user numbers can be used to determine the number of users that created an RRC connection (e.g., users that have activated their connection from idle mode to active mode for a data transfer). This helps to understand the density level and capacity demand from the cells at a time. When the total number of people increases in a region, concurrent eRRC connected user numbers are increased on cells in the region.

Handover attempts can be enriched with handover events extracted from the geolocated call trace logs. Handover attempts data can help establish relationships between the cells 105. The performance metric data are time-series data describing the state of the cellular wireless network 101 at different time intervals. These time intervals, drawn from historical data, can provide insights into the past states of the cellular wireless network 101.

The collected performance metric data can be preprocessed for elimination of duplicates and null values followed by normalization and transformation operations, for example to store in a centralized analytics database.

The performance metric data can represent different event sizes and/or different types of events. The number of people 122 and UEs 120 in the area 100 can vary with event size and/or event type. Additionally, or alternatively, the movement of people 122 and UEs 120 within the area 100 can vary with event size and/or event types. For example, during a sports event more people 122 (and UEs 120) may be located outside the stadium 122 and/or in restaurants/bars 130 than during a concert. In another example, people 122 (and UEs 120) may arrive earlier to the area 100 to tailgate or go to restaurants/bars 130 before a football game than before a soccer game.

In step 202, performance metric data for each cell 105 in the area 100 are collected for days (or time periods) in which a scheduled event did not occur.

In step 203, the GNN model is trained using the performance metric data collected in steps 201 and 202. The decision module 150 can trigger and/or initiate the training of the GNN model, for example using a scheduler in the decision module 150. Additionally, or alternatively, the GNN model can be trained on and/or using the decision module 150. In other embodiments, a different ML model can be trained using the performance metric data.

During training, the goal is to minimize the error between true values Yₜ^{true} (e.g., observed historical data) and predicted values Yₜ^{pred}. A loss function, such as Mean Squared Error (MSE), can be used to quantify this error. Minimizing this loss function through training can improve the accuracy and reliability of the model.

Once the historical data is input, the model applies its algorithms to process and learn from this information. This can include forward propagation of the data through the network layers, backpropagation, and optimization using a predefined loss function.

To adjust the model parameters effectively, the training process utilizes a technique known as backpropagation (e.g., backpropagation through time). This technique calculates gradients not just across the network's structure but also backward through sequential data points, enabling the model to learn from both spatial and temporal dependencies.

An optimization algorithm, such as Adam or Stochastic Gradient Descent (SGD), is employed to update the model's weights based on the gradients calculated during backpropagation. The optimization algorithm refines the model's ability to predict accurately based on the complex interplay of data points over time.

Throughout the training phase, the model's performance is monitored (e.g., continuously or periodically monitored) against a validation dataset. This monitoring can be used to identify scenarios of overfitting and/or underperformance, enabling timely adjustments to the model's parameters and/or training strategies. In some embodiments, the monitoring process can be automated. For example, the model can be retrained periodically, such as every few months or weeks, using “new” historical data collected during both event days and normal days. This is because topological dynamics in geographic locations can change over time, albeit slowly. For example, introducing a new bus route through the area (or other events such as opening new restaurants in the area) could significantly alter the dynamics in the region. The performance monitoring is fully automated, and re-training is triggered either when necessary-determined automatically through calculations of the loss function on validation datasets-or on a scheduled basis.

In step 204, the trained GNN model is stored. The trained GNN model can be stored in RAN data storage 160 or in the decision module 150.

The trained GNN model can, when given the current state (e.g., performance metric data) of the cellular wireless network 101 in the area 100, predict its future state and capacity requirements at successive time steps. In some embodiments, the trained GNN can predict the future state and capacity requirements of the cellular wireless network 101 in the area 100 in advance of a scheduled event. This can facilitate the forecasting of various node features. The structure of the trained GNN can either remain static or dynamic. The trained GNN can aggregate features across the graph based on edge weights, effectively defining the neighborhoods of nodes and the strength of their connections. This approach offers a powerful tool for modeling complex network dynamics, with applications ranging from energy-saving strategies during events, including scheduled events, to other domains where time-series data depict the behaviors of nodes and edges within a graph.

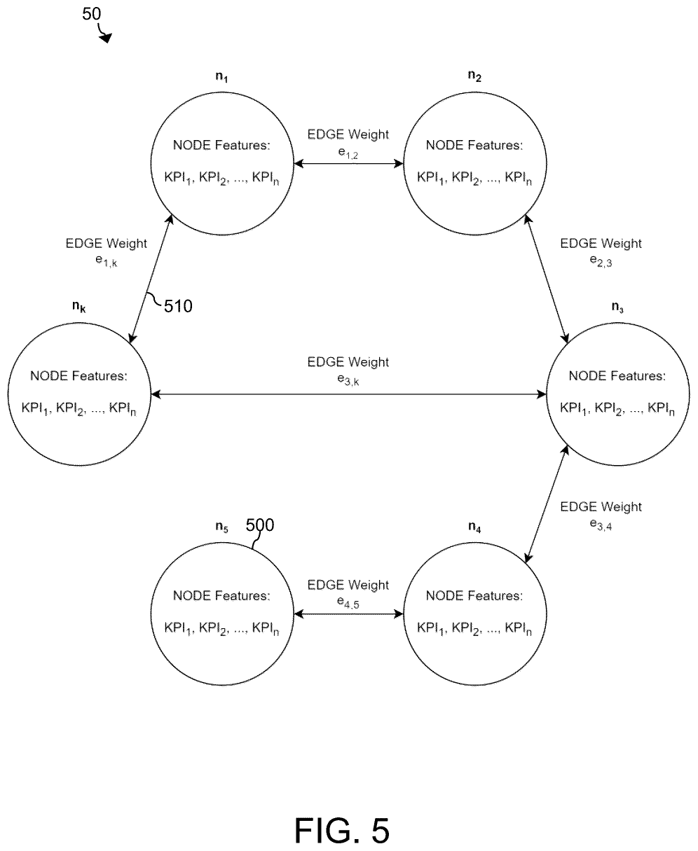

In telecommunications, data frequently adopts a structured format well-suited for representation as a graph network, for example as illustrated in FIG. 5. In this scenario, the graph includes nodes, each representing radio network cells. The features associated with each node include KPIs, while the connections, or edges, between nodes signify handover relationships among them. GNNs, a category of deep learning techniques engineered to make sense of data organized in the form of graphs, are utilized for the analysis and prediction on this structured data.

The purpose of GNNs is to learn and predict the state of a graph network for future time intervals. The GNN can be trained with a representation of the utilization metrics of radio network cells and the relational handover activities and geolocated call trace events among each other for each time interval as a graph. The GNN then generates a comprehensive representation that combines spatial and temporal aspects of the graph network's state. Following this, a fully connected GNN takes an aggregated representation of a graph network, that represents a cellular wireless network at a time before an event (e.g., a scheduled event), as input and generates predictions for the future states of the graph network. GNNs demonstrate exceptional versatility, capable of predicting information at various levels within the graph network. This includes individual nodes, connections between nodes (edges), and even the entire graph network.

These predictions leverage historical data and spatial relationships, employing a combination of diverse building blocks to encode spatial and temporal information in distinct ways. These building blocks are organized into specific configurations known as model architectures. They manage spatial information using techniques such as graph convolutions and handle temporal information through methods like Long-Short Term Memory (LSTM) or Gated Recurrent Unit (GRU). Furthermore, building blocks control data and its flow within the model architecture, integrating tools such as batch normalization, layer normalization, and activation functions.

Building an efficient predictive model entails the careful selection and systematic arrangement of suitable foundational building blocks. The accuracy of predictions relies on the chosen model architecture and the analyzed data's inherent characteristics. We employ the GNN approach to model wireless cellular networks, which exhibit time-series data patterns common in the telecommunications domain. This approach enables us to analyze cellular network elements. We can determine how changes in one node impact others and quantify these effects. By utilizing GNNs in wireless cellular networks, which inherently exhibit interconnections, we not only enhance prediction accuracy but also reduce computational demands when compared to traditional time-series prediction methods. For example, conventional methods often incorporate spatial correlations as external factors, rendering them computationally expensive or even impractical for large-scale applications in mobile network management.

The selection of model architecture and the characteristics of the data are pivotal factors influencing prediction accuracy. Hence, the building blocks discussed can be flexibly combined to create different versions of the overall model architecture within the telecommunications domain. This adaptability allows us to tackle diverse tasks not just in energy conservation but also in other areas like load distribution optimization and beamforming all of which can be directly or indirectly impacted by user interactions within the cellular network.

For modeling a cellular network with numerous interconnected cells, we are using a graph structure. Within this graph, cells 105 are represented as nodes, and the relationships between them, known as handovers, are depicted as edges. Our objective is to employ GNNs to predict KPIs at the level of individual nodes. This entails forecasting the behavior of various network elements for load and capacity awareness to orchestrate energy savings activities over the distribution of UE (e.g., cellular wireless devices such as cellular phones), by time in congested geographical areas, for example within an area surrounding an event location.

Our approach incorporates a constrained multi-variable forecasting challenge. It considers multi-dimensional time-series data for each node and assigns weights to the edges. These edge weights are derived from time-series data related to handover interactions, reflecting the average amount of UE transfers between nodes (e.g., cells 105). The node characteristics influence each other through these edge weights, impacting the overall dynamics of the network. While our approach is showcased in the context of conserving energy during planned special events, particularly when deviations from historical patterns are prevalent, its applicability extends effectively to a broad spectrum of scenarios and tasks. This is due to its capability to generate forecasts for every node in the graph. In this system, each node within the network comprises a multitude of node features, and it can be connected to one or more edges, each assigned an edge weight. These node features and edge weights can vary across different states (e.g., times) of the graph network. In some cases, our network representation is tailored to model the utilization of mobile networks. Here, the graph nodes correspond to diverse cell utilization metrics or counters, while the graph edges symbolize directional handover relationships, when applicable. Each state of the graph network encompasses node features in time steps (e.g., a 15 minutes) such as total data traffic volume (e.g., in megabytes) for downlink and/or uplink, physical resource block utilization for downlink and uplink, as well as other KPIs related to radio resource control and connected users count for the corresponding 15 minute interval in time. Additionally, the edge weights encompass values in averages of time steps (e.g. within an aggregated week period) such as handover related KPIs between nodes.

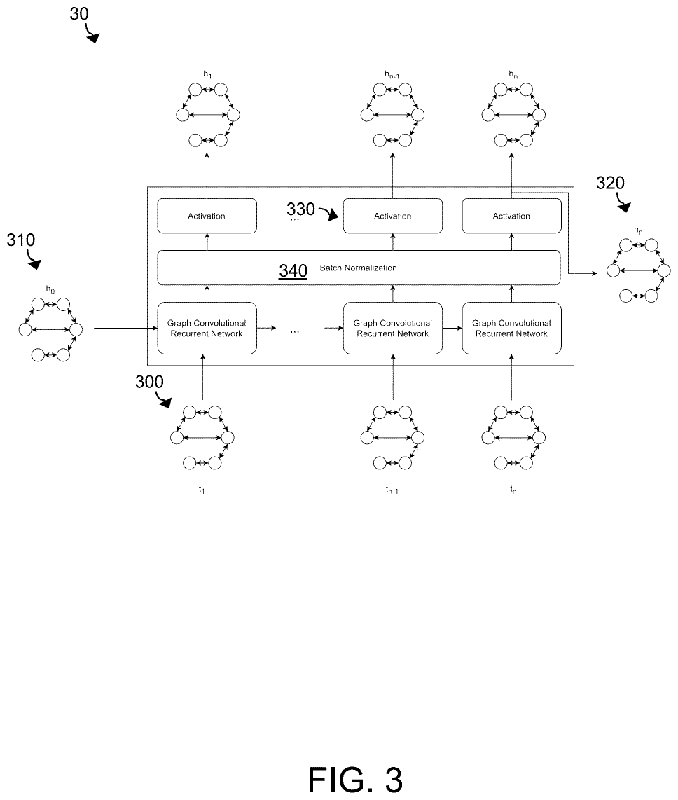

FIG. 3 shows a simplified model of a GNN 30 according to an embodiment. Inputs comprising graph networks 300 labelled “t₁” up to “tₙ” represent the current (or most-recent) state of the cellular wireless network 101 in the area 100, as indicated by the performance metric data, at each timestep. To train a GNN, the graph networks 300 represent historical performance metric data for the cells 105 in the area 100 at time periods when there were events and at time periods when there were no events. To predict using a trained GNN, the graph networks 300 represent a current snapshot (e.g., predetermined time period) of performance metric data before an event. Graph network 310 (h₀) is an initial hidden state. The graph networks h₁ to hₙ represent hidden states for time steps 1 to n, respectively. The hidden states include a collection of features that the GNN deems important about that node, derived both from the node itself and its neighbors (other cells and handover relations). Graph network 320 (hₙ) is the model's output which is an aggregation of previous states of graph network in each timestep according to edge weights.

Batch normalization 340 can comprise spatiotemporal batch normalization. The activation function 330 includes other pieces that come after or are joined with this initial part to make the whole activation function. The choice and implementation of an activation function can be a foundational or preliminary step. The GNN 30 can implement graph convolution with a GRU. A GRU is a type of artificial neural network building block that is widely used in the processing of sequential data, such as time series analysis or natural language processing. GRUs are a variant of recurrent neural networks (RNNs), which are designed to handle sequences of data by having loops within them, allowing information to persist. The GRU(s) can be replaced with LSTM(s).

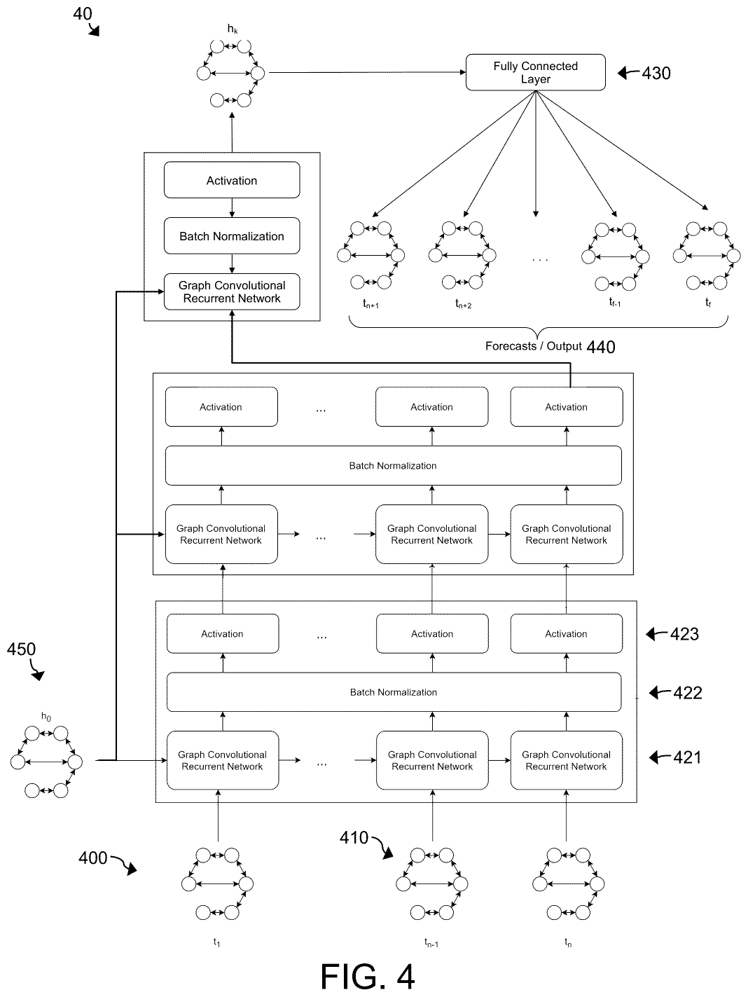

FIG. 4 shows a specific implementation of a GNN 40 according to an embodiment. The GNN 40 outputs future predictions given input 400 of performance metric data of the cellular wireless network 101 in the area 100 in at each timestep t₁ to tₙ which represent the current (or most-recent) state of the cellular wireless network 101 as indicated by the performance metric data, at each timestep. The inputs 400 include graph networks 410 with each node 500 (FIG. 5) representing a respective cell 105 and having respective node features (e.g., KPIs) that represent the performance metric data for the cell 105 at the prediction time. The performance metric data can include total data traffic volume (e.g., downlink and/or uplink total data traffic volume), downlink PRB utilization, uplink PRB utilization, and/or connected eRRC user numbers (count). In some embodiments, the performance metric data can include total data traffic volume (e.g., downlink and/or uplink total data traffic volume), downlink PRB utilization, uplink PRB utilization, and connected eRRC user numbers (count). The edges 510 (FIG. 5) represent the average number of handover activities (e.g., average number of handover completions and/or average number of handover attempts) between the cells 105 connected by each edge 510. The inputs can also include a null graph network 450.

This specific implementation can be used to determine or predict the future load on the cellular wireless network 101 in the area 100 and the energy-savings state of cells 105 in the area 100 during an event such a scheduled event. The prediction length and historical data length is chosen as 20 timesteps. Each time step is equal to 15 minutes making the prediction length and historical data length 5 hours. In other embodiments, each time step can have another length such as 15 minutes, 30 minutes, or another time increment. The prediction length and historical data length can be a different number of timesteps in other embodiments.

The GNN 40 encodes spatiotemporal interactions for both nodes 500 and edges 510 (FIG. 5). In this manner, the GNN 40 is configured to model spatiotemporal changes in the graph network 410. The model used for the GNN 40 implements a specific combination of the simplified GNN 30 which includes a graph convolutional recurrent network layer 421, a normalization layer 422, an activation layer 423, and a fully connected layer 430. The fully connected layer 430 is configured to receive the aggregated state of the graph network 410 (i.e., the aggregated state of the current (or most-recent) state of the cellular wireless network 101 as indicated by the performance metric data, at each timestep) as an input to predict the state of the graph network 410 (e.g., as predicted data 440 which can be represented as graph network 410) at one or more future time steps. For example, the fully connected layer 430 is configured to output a sequence of predicted data 440 including predicted states tₙ₊₁, tₙ₊₂, . . . , t_{f} at one or more future time steps.

The state of the graph network 410 at one or more future time steps (i.e., predicted data 440) represents the predicted future load on the cellular wireless network 101 in the area 100, which can be used to determine the state (e.g., energy-savings or operational) of each cell 105. A graph network 410 is produced for each prediction time (e.g., for tₙ₊₁, for tₙ₊₂, . . . for t_{f-1}, and for t_{f}). At each prediction time, the nodes 500 (FIG. 5) of the predicted data 440 represent the predicted node features (e.g., KPIs) that represent the predicted performance metric data for the cells 105 at a respective prediction time. The predicted performance metric data can include, for each prediction time, total data traffic volume, (e.g., downlink and/or uplink total data traffic volume), downlink PRB utilization, uplink PRB utilization, and/or connected eRRC user numbers (count). In some embodiments, the predicted performance metric data can include, for each prediction time, total data traffic volume, (e.g., downlink and/or uplink total data traffic volume), downlink PRB utilization, uplink PRB utilization, and connected eRRC user numbers (count). At each prediction time, the edges 510 (FIG. 5) represent the predicted average number of handover activities (e.g., average number of handover completions and/or average number of handover attempts) between the cells 105 connected by each edge 510.

FIG. 5 shows an example graph network 50 at an example timestep for a cellular wireless network 101. The graph network 50 can be the same as the graph network 30 and/or the graph network 410. The graph network 50 includes k nodes 500 (n₁, n₂, n₃, . . . nₖ), and j*k edges 510 where j represents the identifier of a node 500 from which an edge 500 comes out of and k represents the identifier of a node 500 to which an edge 500 goes in. For example, when an edge extends from node 2 to node 3, the edge 500 can be represented as edge2, 3. Each node 500 represents a respective cell 105. Each edge 510 has an edge weight (e_{1,k}, e_{1,2}, . . . , e_{j,k}) representing the average handovers between neighboring cells 105. Each node 500 has n KPIs as node features (KPI₁, KPI₂, . . . , KPIₙ). During events, such as planned events, n can be equal to 4 or another positive integer. The KPIs can include total data traffic volume (e.g., downlink and/or uplink total data traffic volume), downlink PRB utilization, uplink PRB utilization, connected CRRC user numbers (count), and/or the average number of handover activities (e.g., average number of handover completions and/or average number of handover attempts) between cells 105. In some embodiments, the KPIs can include total data traffic volume (e.g., downlink and/or uplink total data traffic volume), downlink PRB utilization, uplink PRB utilization, connected CRRC user numbers (count), and the average number of handover activities (e.g., average number of handover completions and/or average number of handover attempts) between cells 105. The performance metric data can also include geolocated call trace logs. Handover attempts can be enriched with handover events extracted from the geolocated call trace logs. Handover attempts data can help establish relationships (edges 510) between the cells 105 (nodes 500).

The graph network (G) 50 can be represented as G (V, E) where V defines a set of Nv=|V| nodes 500 and E defines a set of Ne=|E| edges 510. The symbols |V| and |E| represent the cardinality of the sets V and E, respectively. For example, |V| represents the number of nodes in the set V, and |E| represents the number of edges in the set E. The input features are at the first layer of the GNN.

During a training phase, the system is configured to receive training data. The training data includes time series data indicating the state of the graph network at each of a series of time steps. The time steps used in the training data are historical and describe the states of the network at times t₁ through tₙ. The training data is used to train a graph neural network to output a predicted state of the graph network at a successive time step based on a run-time input state, thereby enabling the joint forecasting of node features.

The state of the graph network 50 includes, for each node 500 of the plurality of nodes 500, a plurality of node features that can include KPIs. A GNN aggregates features of the graph network 50 based on node neighborhoods and edge neighborhoods. FIG. 5 shows an example of a graph network 50, and depicts an example of an edge neighborhood e_{1,k} within the graph network 50. Edge e_{1,2} connects nodes n₁ to n₂. Edge e_{1,k} connects nodes n₁ to nₖ. A node neighborhood of Nᵢ of a node nᵢ include other nodes connected to the node nᵢ. FIG. 5 shows an example of a node neighborhood N₁ for the node n₁. The node neighborhood N₁ includes node n₁, n₂, . . . , nₖ where n₁ is connected to nₖ via edge e_{1,k} and n₁ is connected to n₂ via edge e_{1,2}. The node neighborhood N₁ for a given node n₁ includes all the nodes that are directly connected to that node n₁ by an edge e_{1,k}, which can be referred as to a 1-hop neighborhood. The node neighborhood N₁ for a given node n₁ also includes all the nodes that are indirectly connected to that node n₁ by an intermediate node and two edges, which can be referred to as 2-hop neighborhood. In some embodiments, the node neighborhood N₁ for a given node n₁ also includes all the nodes that are indirectly connected to that node n₁ by two intermediate nodes and three edge which can be referred to as 3-hop neighborhood. Other definitions of the node neighborhood N₁ can be used in other embodiments, such as 4-hop neighborhoods, etc.

An edge neighborhood, E_{i,j} of edge e_{i,j} includes edges connected to nᵢ, and nⱼ as well as the nodes nᵢ and nⱼ. The edge neighborhood E_{i,j} for a given edge eᵢ, includes all the edges that are directly connected to that edge eᵢ, by a node which can be referred as to a 1-hop neighborhood. The edge neighborhood E_{i,j} for a given edge eᵢ, also includes all the edges that are indirectly connected to that edge eᵢ, by an intermediate edge and two nodes, which can be referred to as 2-hop neighborhood. In some embodiments, the edge neighborhood E_{i,j} for a given edge eᵢ, also includes all the edges that are indirectly connected to that that edge eᵢ, by two intermediate edges and three nodes which can be referred to as 3-hop neighborhood. Other definitions of the edge neighborhood N₁ can be used in other embodiments, such as 4-hop neighborhoods, etc.

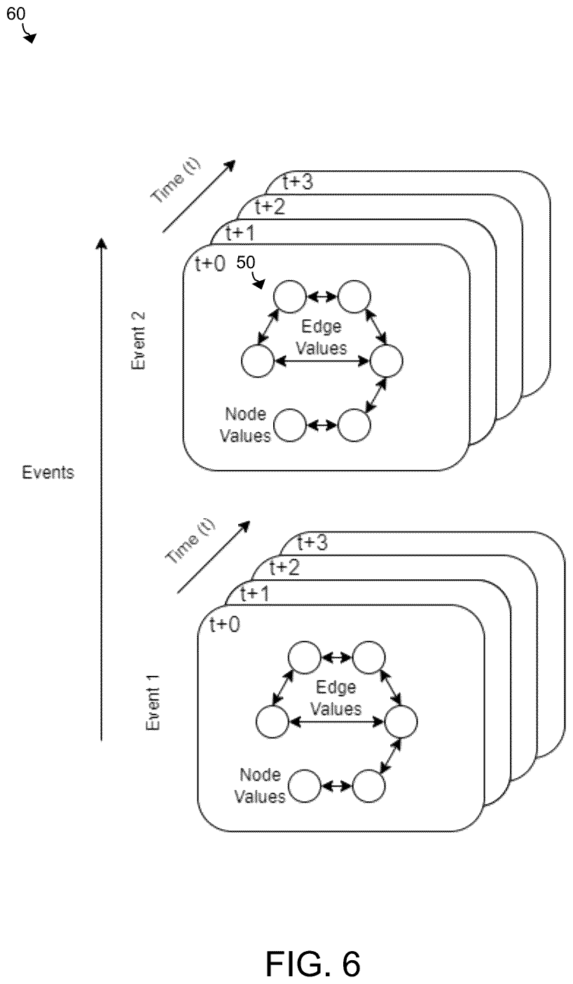

FIG. 6 illustrates example training data 60 used to train a GNN. The training data 60 includes performance metric data for the cellular wireless network 101 at various times (e.g., time intervals) for multiple events. The training data 60 can be stored as four-dimensional tensors (e.g., handover attempt counts, time intervals of events, node utilization statistics during each time interval, edge relational statistics during each time interval). Each time or time interval can be represented as a respective graph network 50.

The example training data 60 is used to train a GNN, which, when given the current state of the network, can predict its future state at successive time steps. This facilitates the forecasting of various node features. The structure of the graph network can either remain static or dynamic. The GNN aggregates features across the graph network based on edge weights, effectively defining the neighborhoods of nodes 500 and the strengths of their connections. This approach offers a powerful tool for modeling complex network dynamics, with applications ranging from energy-saving strategies during special events to other domains where time-series data depict the behaviors of nodes and edges within a graph.

During a run-time phase, the trained GNN is configured to receive run-time input data. The run-time input data includes time series data indicating a run-time state of a graph network 50 at each of a series of time steps. The run-time state includes for each node 500 a plurality of run-time node features (e.g., performance metric data such as KPIs). The run-time input data is input into the trained GNN to thereby cause the trained GNN to output a predicted state of the graph network 50 at one or more future time steps. The predicted state includes, for each node, a plurality of predicted node features (e.g., performance metric data such as KPIs). In this manner, the system can accurately forecast features of nodes 500 at successive time steps.

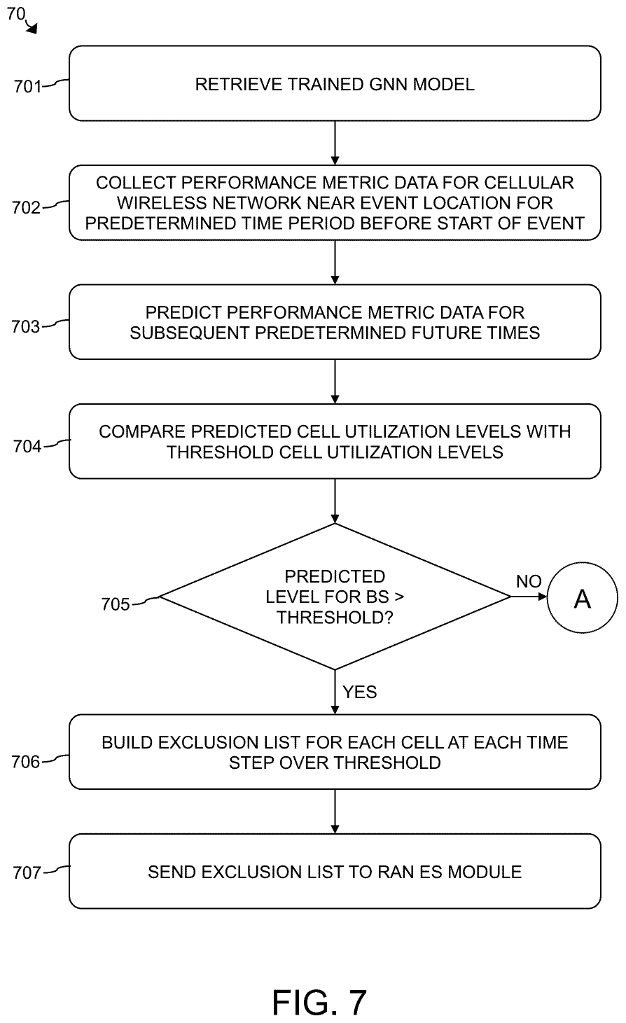

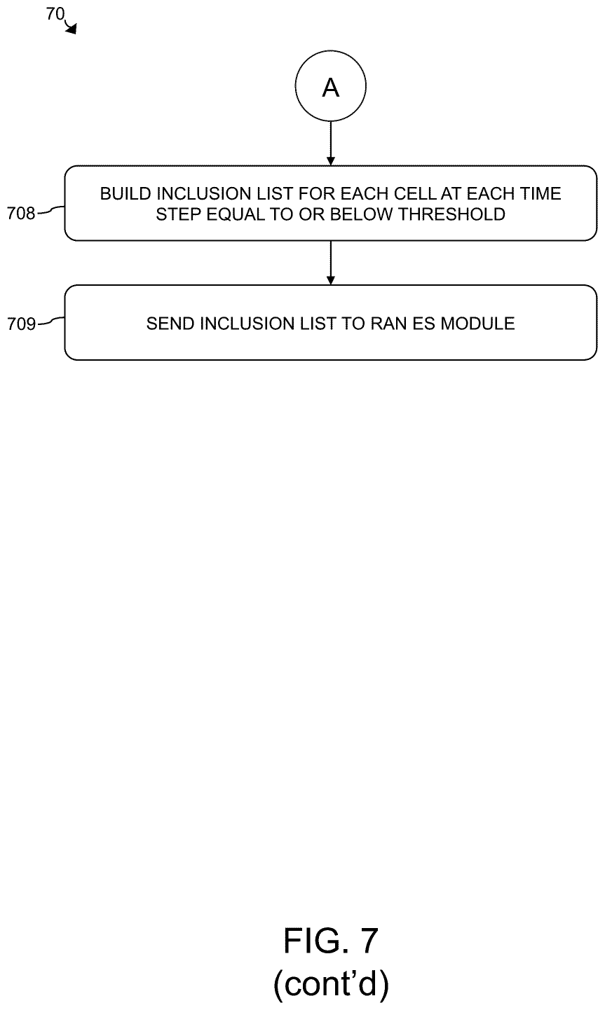

FIG. 7 is a flow chart of a method 70 method for determining energy-savings states of cells 105 in a cellular wireless network 101 in an event zone according to an embodiment.

In optional step 701, a decision module 150 retrieves a trained GNN model (e.g., trained ML model 152) from a server such as from RAN data storage 160. When step 701 is not performed, the decision module 150 can already have the trained GNN model in memory. Alternatively, the decision module 150 can access the trained GNN via function calls (e.g., via an application programming interface (API)). The trained GNN model can be specific for a given event zone.

In step 702, performance metric data for the cellular wireless network 101 are collected for a predetermined time period before the start of an event. The performance metric data includes KPIs for each cell 105 in the area 100 such as total data traffic volume (e.g., downlink and/or uplink total data traffic volume), downlink PRB utilization, uplink PRB utilization, and/or connected eRRC user numbers (count). In some embodiments, the performance metric data includes total data traffic volume (e.g., downlink and/or uplink total data traffic volume), downlink PRB utilization, uplink PRB utilization, and connected eRRC user numbers (count). The performance metric data can also include the average number of handover events and/or the average number of handover between cells 105 and the identity of the cells 105 for each handover event and/or for each handover attempt. The handovers can be between cells 105 for the same base station 102 and/or between cells 105 for different base stations 102.

The performance metric data can be represented in the same or similar way as the training data 60 (FIG. 6) but the performance metric data is from a predetermined time period before the start of an event.

In step 703, the decision module 150 feeds the performance metric data collected in step 702 into the trained GNN model to predict performance metric data for multiple predetermined times in the future. The performance metric data can be predicted for multiple future time steps such as every 15 minutes, every 30 minutes, every hour, or another time step over a predetermined time period such as for a total of 3 hours, 4 hours, 5 hours, or another predetermined time period. The performance metric data can be transformed into graph networks 50 before the performance metric data is fed to the trained GNN model. Each graph network can represent a time step in the predetermined time period in which the performance metric data is collected.

The predicted performance metric data can be represented as graph networks 50, with each graph network representing a respective future time step.

In step 704, the decision module 150 compares the predicted performance metric data with one or more threshold cell utilization levels that can be defined in an MNO policy. Examples of the threshold cell utilization levels include a threshold total data traffic volume, a threshold downlink PRB utilization, a threshold uplink PRB utilization, and/or threshold connected eRRC user numbers (count). The comparison is made for each cell 105 at each future time step.

In step 705, the decision module 150 determines whether the predicted performance metric data for each cell 105 is greater than at least one of the threshold cell utilization level(s) at any future time step.

For each cell 105 in which the predicted performance metric data is higher than at least one of the threshold cell utilization level(s) at any future time step, an exclusion list is created in step 706. For example, if the predicted PRB_Utilization for downlink (predicted downlink PRB utilization)>threshold1 OR the predicted eRRC user numbers>threshold2 for a cell 105 at a future time step, that cell 105 would be added to the exclusion list for that future time step and no energy savings activities would be applied for that time period. In other embodiments, the predicted performance metric data can be compared to only one cell utilization level. For example, if the predicted PRB_Utilization for downlink (predicted downlink PRB utilization)>threshold1, for a cell 105 at a future time step, that cell 105 would be added to the exclusion list for that future time step. In another example, if the predicted eRRC user numbers>threshold2, for a cell 105 at a future time step, that cell 105 would added to the exclusion list for that future time step. In another example, if the PRB_Utilization for uplink (predicted uplink PRB utilization)>threshold3, for a cell 105 at a future time step, that cell 105 would added to the exclusion list for that future time step. In another example, if the predicted PRB_Utilization for uplink (predicted uplink PRB utilization)>threshold3 OR the predicted eRRC user numbers>threshold2 for a cell 105 at a future time step, that cell 105 would be added to the exclusion list for that future time step and no energy savings activities would be applied for that time period. In another example, if the predicted PRB_Utilization for downlink (predicted downlink PRB utilization)>threshold1 OR the predicted PRB_Utilization for uplink (predicted uplink PRB utilization)>threshold3 OR the predicted eRRC user numbers>threshold2 for a cell 105 at a future time step, that cell 105 would be added to the exclusion list for that future time step and no energy savings activities would be applied for that time period.

The exclusion list identifies the cell 105 and the future time period(s) for which the threshold cell utilization level(s) is/are predicted to be exceeded. The exclusion list can also identify the base station 102 for each cell 105 on the exclusion list. The exclusion list represents the cells 105 that will be placed in an operational state (and not in an energy-savings state) over any future time periods due to their predicted utilization levels. A simplified example of an exclusion list is shown in Table 1. Std. and T. hub refer to stadium and transportation/transport hub respectively.

TABLE 1

| CELL ID | START | END | DURATION |
|---|---|---|---|
| Std. Cell A | 22 Aug. 2024 21:45 | 23 Aug. 2024 00:00 | 02:15 |
| Std. Cell B | 22 Aug. 2024 22:00 | 23 Aug. 2024 00:00 | 02:00 |
| Std. Cell C | 22 Aug. 2024 22:00 | 22 Aug. 2024 23:45 | 01:45 |
| T. Hub Cell A | 22 Aug. 2024 21:45 | 23 Aug. 2024 01:30 | 03:45 |
| T. Hub Cell B | 22 Aug. 2024 21:45 | 23 Aug. 2024 01:30 | 03:45 |
| T. Hub Cell C | 22 Aug. 2024 21:45 | 23 Aug. 2024 02:15 | 04:30 |

In step 707, the decision module 150 sends the exclusion list to the RAN ES module 140. The RAN ES module 140 then implements the exclusion list by causing only the cell 105 identified in the exclusion list to be placed in an operational state (i.e., not in an energy-savings state). The RAN ES module 140 can implement the exclusion lists via Element Management System (EMS) interfaces to turn-off/on features by changing their parameters or via a REST API provided through a North Bound Interface (NBI) of the EMS System. For example, the RAN ES module 140 can change parameters in the Carrier and Cell Switch (e.g., off/on), the RF Channel Reconfiguration (e.g., off/on), and/or in Advanced Sleep Mode Management.

For each cell 105 in which the predicted performance metric data is lower than or equal to all of the threshold cell utilization level(s) at any future time step, an inclusion list is created in step 708 (via placeholder A). For example, if the predicted PRB Utilization for downlink (predicted downlink PRB utilization)≤threshold1 AND the predicted eRRC user numbers≤threshold2 for a cell 105 at a future time step, that cell 105 would be added to the inclusion list for that future time step and energy savings activities would be applied for that time period. In other embodiments, the predicted performance metric data can be compared to only one cell utilization level. For example, if the predicted PRB_Utilization for downlink (predicted downlink PRB utilization)≤threshold1, for a cell 105 at a future time step, that cell 105 would be added to the inclusion list for that future time step. In another example, if the predicted eRRC user numbers≤threshold2, for a cell 105 at a future time step, that cell 105 would added to the inclusion list for that future time step. In another example, if the PRB_Utilization for uplink (predicted uplink PRB utilization)≤threshold3, for a cell 105 at a future time step, that cell 105 would added to the exclusion list for that future time step. In another example, if the predicted PRB Utilization for uplink (predicted uplink PRB utilization)≤threshold3 AND the predicted eRRC user numbers≤threshold2 for a cell 105 at a future time step, that cell 105 would be added to the inclusion list for that future time step and energy savings activities would be applied for that time period. In another example, if the predicted PRB Utilization for downlink (predicted downlink PRB utilization)≤threshold1 AND the predicted PRB Utilization for uplink (predicted uplink PRB utilization)≤threshold3 AND the predicted eRRC user numbers≤threshold2 for a cell 105 at a future time step, that cell 105 would be added to the inclusion list for that future time step and energy savings activities would be applied for that time period.

The inclusion list identifies the cells 105 and the future time period(s) for which the threshold cell utilization level(s) is/are predicted to be met. The inclusion list represents the cells 105 that will be placed in an energy-savings state (and not in an operational state) over any future time periods due to their predicted utilization levels. The inclusion list can also identify the base station 102 for each cell 105 on the inclusion list. A simplified example of an inclusion list is shown in Table 2.

TABLE 2

| CELL ID | START | END | DURATION |
|---|---|---|---|
| Std. Cell A | 22 Aug. 2024 19:00 | 22 Aug. 2024 21:45 | 02:45 |
| Std. Cell B | 22 Aug. 2024 18:30 | 22 Aug. 2024 22:00 | 03:30 |
| Std. Cell C | 22 Aug. 2024 23:45 | 23 Aug. 2024 02:00 | 02:15 |
| T. Hub Cell A | 22 Aug. 2024 18:00 | 22 Aug. 2024 21:45 | 03:45 |
| T. Hub Cell B | 22 Aug. 2024 18:30 | 22 Aug. 2024 21:45 | 03:15 |
| T. Hub Cell C | 22 Aug. 2024 18:15 | 22 Aug. 2024 21:45 | 03:30 |

In step 709, the decision module 150 sends the inclusion list to the RAN ES module 140. The RAN ES module 140 then implements the inclusion list by causing only the cells 105 identified in the inclusion list to be placed in an energy-savings state (i.e., not in an operational state). The RAN ES module 140 can implement the inclusion lists via EMS interfaces to turn-off/on features by changing their parameters or via a REST API provided through an NBI of the EMS System. For example, the RAN ES module 140 can change parameters in the Carrier and Cell Switch (e.g., off/on), the RF Channel Reconfiguration (e.g., off/on), and/or in Advanced Sleep Mode Management.

In some embodiments, the method 70 can only create an exclusion list in which case steps 706 and 707 are performed and steps 708 and 709 are not performed. Since the inclusion list is effectively, at least in some embodiments, the inverse of the exclusion list, the decision module 150 or the RAN ES module 140 can deduce the inclusion list from the exclusion list.

In other embodiments, the method 70 can only create an inclusion list in which case steps 708 and 709 are performed and steps 706 and 707 are not performed and. Since the exclusion list is effectively, at least in some embodiments, the inverse of the inclusion list, the decision module 150 or the RAN ES module 140 can deduce the exclusion list from the inclusion list.

The energy-saving mechanisms are effectively suspended (e.g., ES=Deactivated) for the cells 105 at the times indicated in the exclusion list. This suspension entails a cessation of the cell's active participation in energy-saving algorithms. The remaining cells, as specified in the inclusion list, persist or initiate energy-saving endeavors, referred to as energy saving being Activated (ES=Activated). This demarcation ensures that, despite the exclusion of certain cells, the overall network or system sustains and/or commences energy-saving measures in line with the defined criteria. This approach not only optimizes energy consumption around the event venue but also introduces a strategic and nuanced implementation of energy-saving strategies, thereby contributing to the overall efficiency and sustainability of the system during planned special events. The energy saving algorithms can be a centralized self-organizing network (SON) application, an Open-RAN (O-RAN) supported Radio Intelligent Controller (RIC) application, and/or another energy saving method or algorithm. The energy-savings methods/algorithms can take actions with radio resource graceful switch-offs with respect to idle/busy period capacity levels. The disclosed systems and methods are independent from the type of energy-savings algorithm(s) utilized in the mobile network and focuses on the awareness of capacity demand per cell during and after the high impact of local events in crowded venues like sports competition arenas, concert, and performance venues, etc.

The RAN ES module 140 processes the exclusion list provided by decision module 150 and disables the energy saving feature on any cells 105 identified in the exclusion list for the time limitation provided in the exclusion lists. This means some of the cells 105 in the nearby area will not be excluded from energy saving activities (graceful radio resource switch-offs) at all whereas some others will be excluded from energy saving activities between specific times due to expected load levels during those hours.

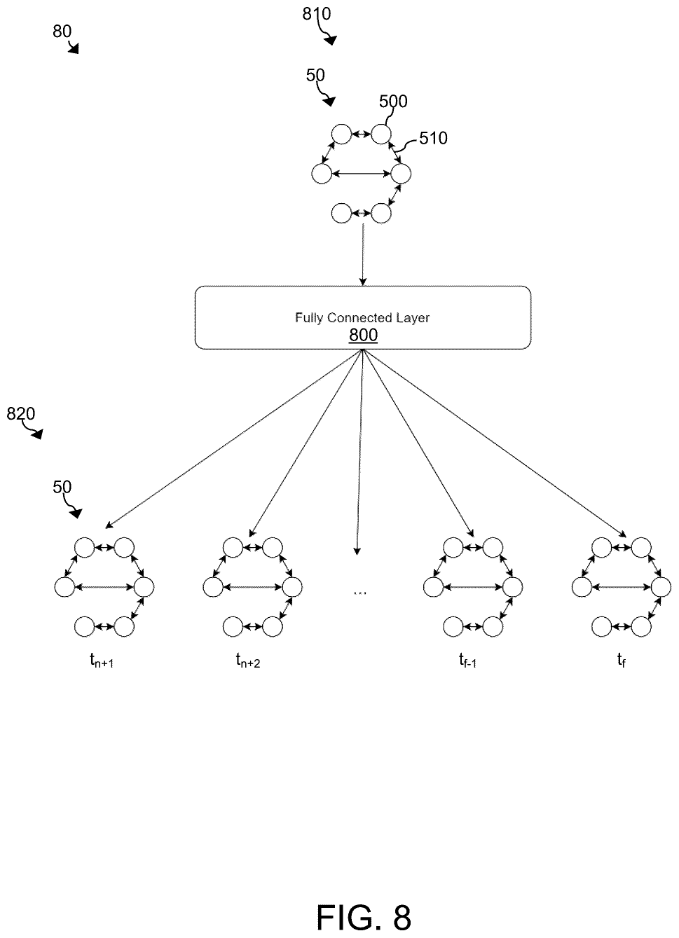

FIG. 8 illustrates an example of a final prediction layer 80. The final prediction layer 80 is a building block to form a GNN model. A fully connected layer 800 receives input data 810 from other layers in the GNN and produces predicted data 820. The fully connected layer 800 can be the same as the fully connected layer 430 (FIG. 4). The predicted data 820 can be the same as the predicted data 440 (FIG. 4).

The predicted data 820 represents the predicted state of the cellular wireless network 101 at various prediction times (e.g., time steps). A graph network 50 is produced for each prediction time (e.g., for tₙ₊₁, for tₙ₊₂, . . . for t_{f-1}, and for t_{f}). At each prediction time, the nodes 500 of the predicted data 820 represent the predicted node features (e.g., KPIs) that represent the predicted performance metric data for the cells 105 at a respective prediction time. The performance metric data can include, for each prediction time, total data traffic volume (e.g., downlink and/or uplink total data traffic volume), downlink PRB utilization, uplink PRB utilization, and/or connected eRRC user numbers. In some embodiments, the performance metric data can include, for each prediction time, total data traffic volume (e.g., downlink and/or uplink total data traffic volume), downlink PRB utilization, uplink PRB utilization, and connected CRRC user numbers. At each prediction time, the edges 510 represent the predicted average number of handover activities (e.g., average number of handover completions and/or average number of handover attempts) between the cells 105 connected by each edge 510.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method for determining energy-savings states of cellular network components in an event zone, comprising:
retrieving, with a decision module, run-time performance metric data for cells in a predetermined area of a cellular wireless network corresponding to an event location, the run-time performance metric data representing a predetermined time period before a start time of an event;
feeding the run-time performance metric data to a trained machine-learning (ML) model in the decision module, the trained ML model having been trained with first historical performance metric data representing no events at the event location and second historical performance metric data representing events at the event location;
determining, using the trained ML model and the run-time performance metric data, predicted cell utilization levels for the cells over a predicted time period, the predicted time period subdivided into a plurality of predicted time increments;
comparing, with the decision module, one or more respective predicted cell utilization levels for each cell to one or more respective thresholds; and
building, with the decision module, an inclusion list that includes an identity of each cell for which at least one of the one or more respective predicted cell utilization levels is/are lower than or equal to the one or more respective thresholds, the inclusion list further including a respective one or more predicted time increments in which the at least one of the one or more respective predicted cell utilization levels of a respective cell is/are lower than or equal to the one or more respective thresholds.

2. The method of claim 1, further comprising sending the inclusion list from the decision module to a Radio Access Network Energy Saving (RAN ES) Module, the RAN ES Module configured to cause each cell identified in the inclusion list to transition from an operational state to an energy-savings state during the respective one or more time periods.

3. The method of claim 1, wherein the one or more respective predicted cell utilization levels comprises a respective downlink physical resource block utilization and/or a respective uplink physical resource block utilization.

4. The method of claim 1, wherein the one or more respective predicted cell utilization levels comprises respective connected enhanced radio resource control user numbers.

5. The method of claim 1, wherein the one or more respective predicted cell utilization levels comprises a respective downlink physical resource block utilization, a respective uplink physical resource block utilization, and respective connected enhanced radio resource control user numbers.

6. The method of claim 1, wherein:
the respective one or more predicted time increments is/are one or more predicted first time increments, and
the method further comprises building an exclusion list that includes the identity of each cell having the at least one of the one or more respective predicted cell utilization levels that is/are higher than the one or more respective thresholds, the exclusion list further including a respective one or more second predicted time increments in which the at least one of the one or more respective predicted cell utilization levels of a respective cell is/are higher than at least one of the one or more respective thresholds.

7. The method of claim 6, further comprising sending the exclusion list from the decision module to a Radio Access Network Energy Saving (RAN ES) Module, the RAN ES Module configured to cause each cell identified in the exclusion list to be excluded from entering into an energy-savings state during the respective one or more second predicted time increments.

8. The method of claim 1, wherein the trained ML model comprises a trained graph neural network (GNN).

9. The method of claim 8, wherein the first historical performance metric data, the second historical performance metric, and the run-time performance metric data are represented as a plurality of graph networks.

10. The method of claim 9, wherein each graph network includes a plurality of nodes and one or more edges, each node representing the respective cell and each edge has a respective weight corresponding to an average number of handover activities between a respective pair of cells.

11. The method of claim 10, wherein the average number of handover activities includes an average number of handover attempts between the respective pair of cells and/or an average number of handover completions between the respective pair of cells.

12. The method of claim 10, wherein each node has one or more respective node features including a total uplink and/or a total downlink data traffic volume, a downlink physical resource block utilization, an uplink physical resource block utilization, connected enhanced radio resource control user numbers, and/or the average number of handover activities.

13. A computer comprising:
a processor;
non-transitory memory operably coupled to the processor, the non-transitory memory storing computer-readable instructions that, when executed by the processor, cause the processor to run a decision module for determining energy-savings states of cellular network components in an event zone, the decision module configured to:
retrieve run-time performance metric data for cells in a predetermined area of a cellular wireless network corresponding to an event location, the run-time performance metric data representing a predetermined time period before a start time of an event;
feed the run-time performance metric data to a trained machine-learning (ML) in the decision module, the trained ML model having been trained with first historical performance metric data representing no events at the event location and second historical performance metric data representing events at the event location;
determine, using the trained ML model and the run-time performance metric data, predicted cell utilization levels for the cells over a predicted time period, the predicted time period subdivided into a plurality of predicted time increments;
compare one or more respective predicted cell utilization levels for each cell to one or more respective thresholds; and
build an inclusion list that includes an identity of each cell for which at least one of the one or more respective predicted cell utilization levels is/are lower than or equal to the one or more respective thresholds, the inclusion list further including a respective one or more predicted time increments in which the at least one of the one or more respective predicted cell utilization levels of a respective cell is/are lower than or equal to the one or more respective thresholds.

14. The computer of claim 13, wherein the decision module is further configured to send the inclusion list from the decision module to a Radio Access Network Energy Saving (RAN ES) Module, the RAN ES Module configured to cause each cell identified in the inclusion list to transition from an operational state to an energy-savings state during the respective one or more time periods.

15. The computer of claim 13, wherein the trained ML model comprises a trained graph neural network (GNN).

16. The computer of claim 13, wherein:
the respective one or more predicted time increments is/are one or more predicted first time increments, and
the decision module is further configured to build an exclusion list that includes the identity of each cell having the at least one of the one or more respective predicted cell utilization levels that is/are higher than the one or more respective thresholds, the exclusion list further including a respective one or more second predicted time increments in which the at least one of the one or more respective predicted cell utilization levels of a respective cell is/are higher than at least one of the one or more respective thresholds.

17. A method for training a graph neural network (GNN) to predict cell utilization levels for an event zone, comprising:
collecting first performance metric data for cells in a predetermined area surrounding an event venue at a plurality of first times when no events are occurring at the event venue;
collecting second performance metric data for the cells in the predetermined area at a plurality of second times when events are occurring at the event venue; and
training the GNN with the first and second performance metric data.

18. The method of claim 17, wherein the training includes minimizing an error between true values and predicted values.

19. The method of claim 18, further comprising:
converting the first performance metric data to a plurality of first graph networks;
converting the second performance metric data to a plurality of second graph networks; and
training the GNN with the first and second graph networks,
wherein each of the first and second graph networks includes a plurality of nodes and one or more edges, each node representing a respective cell and each edge has a respective weight corresponding to an average number of handover activities between a respective pair of cells, the average number of handover activities including an average number of handover attempts between the respective pair of cells and/or an average number of handover completions between the respective pair of cells.

20. The method of claim 19, wherein each node has one or more respective node features including a total uplink and/or a total downlink data traffic volume, a downlink physical resource block utilization, an uplink physical resource block utilization, connected enhanced radio resource control user numbers, and/or the average number of handover activities.
